(19) United States
(12) Patent Application Publication
(10) Pub. No.: US 2010/0119327 A1
(43) Pub. Date: May 13, 2010

(54) SELF-DRILLING SCREW WITH MULTI-DRILLING PORTIONS

(75) Inventor: KUO-CHANG LIN, KAOHSIUNG COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHAN LIANG ENTERPRISE CO., LTD., KAOHSIUNG COUNTY (TW)

(21) Appl. No.: 12/267,669

(22) Filed: Nov. 10, 2008

(51) Int. Cl. F16B 25/10

(52) U.S. Cl. 411/387.8

(57) ABSTRACT

A self-drilling screw with multi-drilling portions mainly comprises a shank, a head and a drilling portion separately disposed on both ends of the shank, and a thread section spiraled on the shank. Wherein, at least one sub-drilling portion formed amid the drilling portion and the thread section further defines a sequence of indentations and prominent areas, and each indentation generates a cutting surface outwardly extended from one side thereof so as to converge the cutting surface with the adjacent prominent area at a cutting ridge. Accordingly, the application of the cutting ridges and the indentations facilitates the drilling portion with the chipping capability and renders an appropriate guidance to redundant debris, thereby efficiently achieving a swift screwing and the lowered screwing resistance to promote the screwing efficiency.

### BACKGROUND OF THE INVENTION

1. Field of the Invention

The present invention relates to a self-drilling screw, in particular to a self-drilling screw including multi-drilling portions.

2. Description of the Related Art

A conventional drilling screw 1 as shown in FIG. 1 comprises a head 11, a shank 12 outwardly extended from the head 11 forming a drilling portion 13 at the distal end thereof, and a set of thread section 14 spiraling round the shank 12. Wherein, the drilling portion 13 peripherally defines two flutes 131 (only one flute as viewed in the FIG. 1), and a cutting surface 132 is further outwardly extended from the flute 131 so that a cutting edge 133 is formed by the convergence of the flute 131 and the adjoining cutting surface 132. During operation, the cutting edge 132 renders a preliminary drilling to lead the succeeding thread section 14 screwing into an object (not shown) and fix the screw 1 therein.

However, in virtue of the typical punching upon the drilling portion 13 and the sole application of the flutes 131 and cutting edges 133 for processing the cutting and debris guidance, a limited accommodation of debris among the flutes 131 becomes easy to impede the extrusion of the debris in time of drilling and to incur an increment of the screwing torque, which relatively results in snapping of the screw 1. Moreover, the length of the drilling portion 13 is chiefly decided in view of the thickness of the object. Therefore, once the drilling portion 13 is prolonged, the larger and lengthy die is required, which potentially results in the exhaustion of the die under a term of utilization and renders the high manufacturing cost.

The intention of another conventional drilling screw 2 as shown in FIG. 2 was accordingly invented to remedy the shortcomings of the drilling screw 1. The concatenation of associated elements and applications same to those of the first prior art are herein omitted. Wherein, a necking 25 is defined between a drilling portion 23 and a thread section 24, in which an outer diameter d1 of the necking 25 is smaller than an outer diameter d2 of the drilling portion 23. Approaching to the same operation as the conventional screw 1, a cutting edge 233 on the drilling portion 23 renders a preliminary drilling to lead the succeeding shank 22 screwing into an object (not shown). The generated debris would upwardly travel along the flutes 232, and the narrow necking 25 would allocate a clearance for assisting the further advancement of debris, which accordingly intends to diminish the obstruction of the debris in the drilling and renders a fastening capability.

Nonetheless, such necking 25 are preferred merely for purposes of the debris extrusion, decreasing part of the die length, and therefore reducing the cost of a lengthy die. Moreover, in view of the screw 2 commonly designed to engage with a thicker object (not shown), a larger supporting strength would be needed to carry the drilling portion 23 into the object. However, the thinner and fragile necking 25 with the reduced diameter d1 would be subjected to a facile snap in view of its lower resistance unable to bear the drilling pressure, which however would decrease the screwing capability and firmness of the screw 2. Thus, the screw 2 still fails to obviate the deficiencies of the screw 1 and requires improvements.

### SUMMARY OF THE INVENTION

The object of the present invention is to provide a self-drilling screw with multi-drilling portions to achieve a speedy drilling and a decreased screwing torque so as to increase the screwing efficiency.

The self-drilling screw in accordance with the present invention mainly comprises a head, a shank outwardly extended from the head forming a drilling portion to be disposed opposite to the head, and a set of thread section spiraling round the shank. Wherein, at least one sub-drilling portion is further defined between the drilling portion and the thread section and comprised of a sequence of indentations for rendering the performance of a plurality of cutting ridges. In this manner, the sub-drilling portion along with the cutting ridges assists the drilling portion in advancing a preferable preliminary drilling and has the indentations to provide an efficient extrusion of debris, therefore conducing to attaining a decreased screwing resistance and torque, achieving a rapid screwing, and promoting the screwing efficiency.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a perspective view showing a conventional screw;

FIG. 2 is a perspective view showing another conventional screw;

FIG. 3 is an elevation view showing a first preferred embodiment of the present invention;

FIG. 3A is an enlarged view showing of FIG. 3;

FIG. 4 is a schematic view showing the first preferred embodiment screwed in an object;

FIG. 5 is an elevation view showing a second preferred embodiment of the present invention;

FIG. 6 is an elevation view showing a third preferred embodiment of the present invention; and

FIG. 7 is an elevation view showing a fourth preferred embodiment of the present invention.

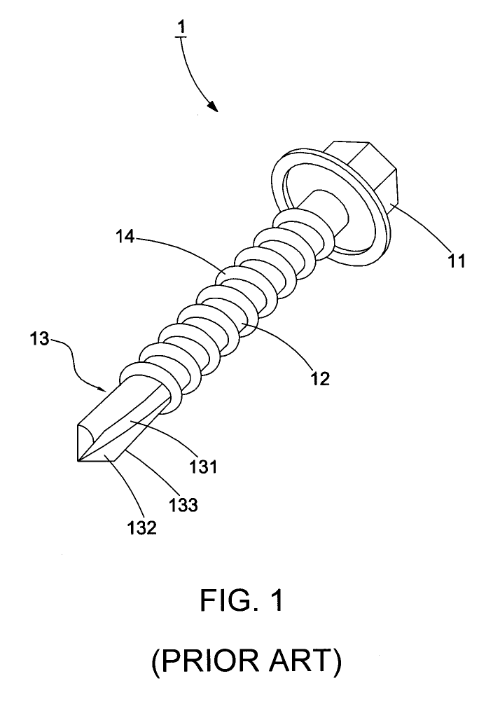

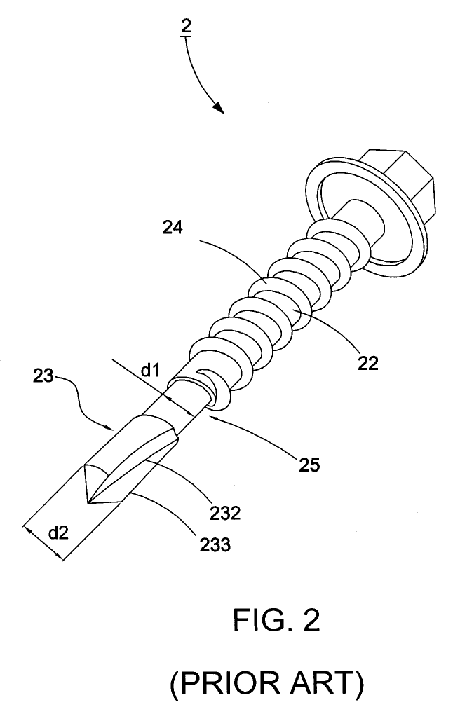

### DETAILED DESCRIPTION OF THE PREFERRED EMBODIMENTS

Before describing in greater detail, it should note that the like elements are denoted by the similar reference numerals throughout the disclosure.

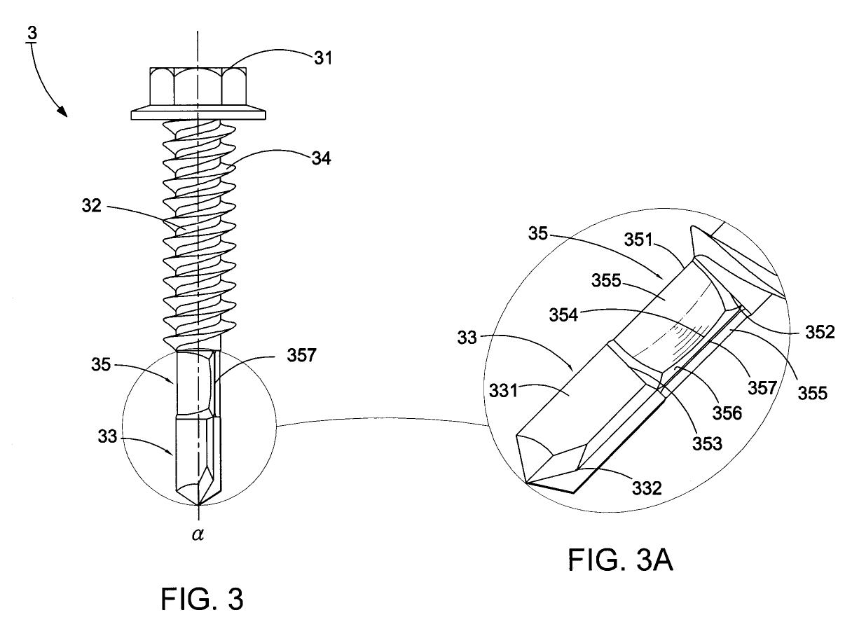

Referring to FIG. 3 showing the present invention, a self-drilling screw 3 of a first preferred embodiment comprises a head 31, a shank 32 outwardly extended from the head 31 forming a drilling portion 33 to be disposed opposite to the head 31, and a set of thread section 34 spiraling round the shank. Wherein, the drilling portion 33 includes a drill bit 331 defined thereon and at least one flute 332 disposed on the drill bit 331. Particularly, a sub-drilling portion 35 is defined between the drilling portion 33 and the thread section 34. It should be noted that the sub-drilling portion could be directly and integrally punched by a mold, which further results in a higher strength.

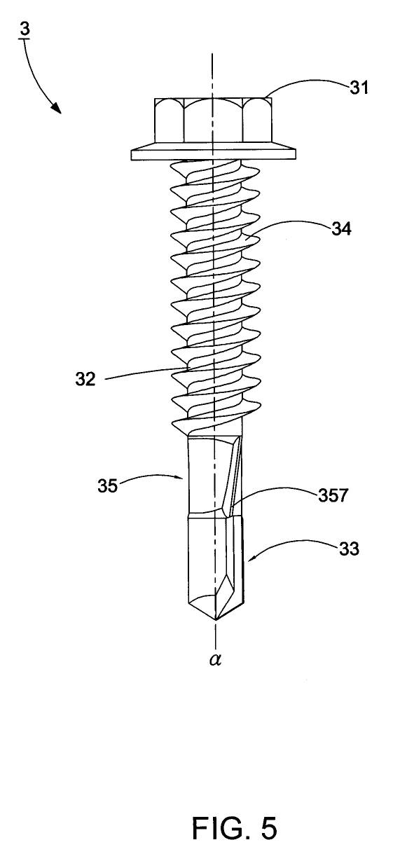

Moreover, the sub-drilling portion 35 further includes a sub-drill body 351, an upper region 352 disposed close to the edge of the thread section 34, and a lower region 353 adjoined with the drill bit 331; the sub-drill body 351 provides with a sequence of indentations 354 and prominent areas 355 defined between the upper and lower regions 352, 353, and each indentation 354 has one side thereof upstream extending to perform a cutting surface 356 so that a cutting ridge 357 is formed where the cutting surfaces 356 and the adjacent prominent area 355 meet. Further, the cutting ridge 357 is parallel to a shank axis α as plainly shown in FIG. 3; alternatively, it should be noted that the cutting ridge 357 could also be inclined to the axis α of the shank 32 as shown in FIG. 5. Herein the descriptions to the operation in this and following embodiments are mainly utilized in connection with the performance of the cutting ridge 357 being in a parallel statement.

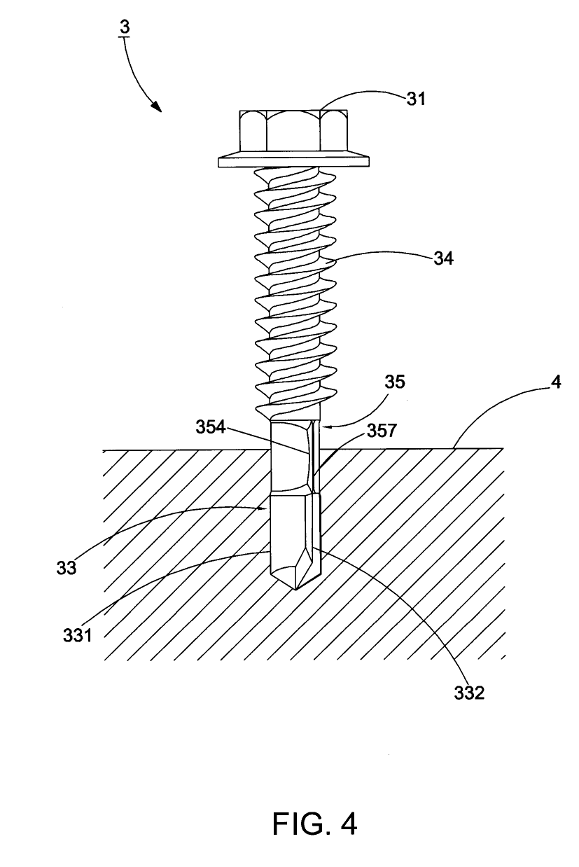

Referring to FIG. 4 showing the operation of the self-drilling screw 3, the drill bit 331 is preliminarily drilled into an object 4 so as to gradually bring the drilling portion 33 drilling thereinto. Hereby, a snap incurred by a large screwing torque can be preferably prevented by means of the sub-drilling portion 35 possessing a constructively higher resistance. Subsequently, the sub-drilling portion 35 continuously contacts the object 4, and the cutting ridge 357 further assists the drilling portion 33 in drilling more deeply so as to aid with the swift advancing of the succeeding thread section 34 through the object 4. Concurrently, the debris generated during the screwing is able to be smoothly moved along the flute 332 (or from the distal end of the drilling portion 33) toward the indentations 354 and thence extruded out. Such gradual drilling substantively prevents the debris from being over accumulated and efficiently obviates the increment of screwing resistance and torque. Therefore, it accordingly averts bluntness resulting from a long term of the screwing friction on the drill bit 331 and promotes the drilling competence.

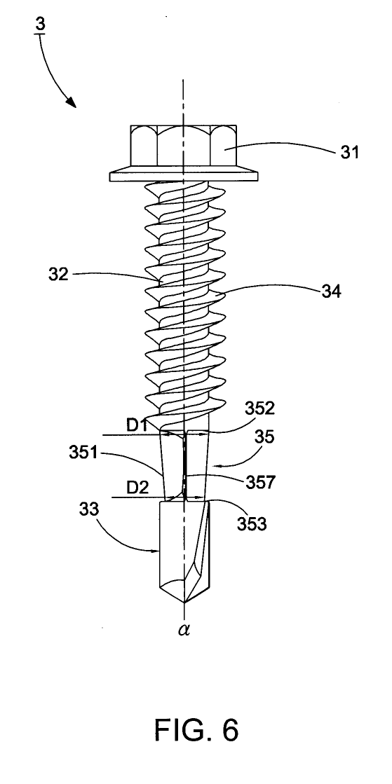

Referring to FIG. 6, a third preferred embodiment of the present invention also comprises a head 31, a shank 32, a drilling portion 33, a set of thread section 34 and a sub-drilling portion 35. The concatenation of correlated elements and applications same to those of the first preferred embodiment are herein omitted. This embodiment is in characterized in that an outer diameter D1 of the upper region 352 is larger than an outer diameter D2 of the lower region 353, whereby the improvement wherein the sub-drill body 351 is of a gradual reduced diameter from the edge of the thread section 34 toward the drilling portion 33 so as to form a necking structure. Thus, a larger accommodation of debris around the sub-drilling portion 35 is further formed thereby to appropriately receive the debris and allow smoothly extruding the redundant debris out, which efficiently lessens the screwing obstruction. Besides, the gradual-reduced structure of the sub-drilling portion 35 could auxiliarily assist the drilling portion 33 in chipping debris and provide the smooth guidance of redundant debris, thereby attaining the diminished drilling resistance and debris obstruction, a swift screwing, and promoting the screwing efficiency. Please notice that the screw 3 in this embodiment is also not restricted to the performance of the cutting ridges 357 of the sub-drilling portion 35 on account of that the cutting ridge 357 is either parallel (shown in FIG. 6) or inclined with respect to the shank axis α (not shown) attains the same objects and purposes set forth above.

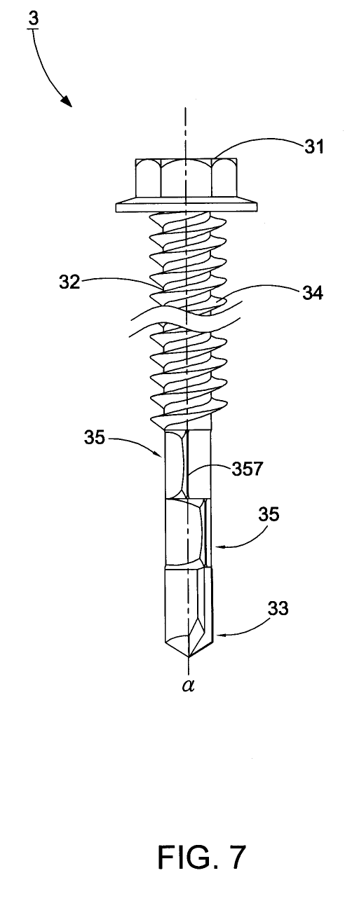

Referring to FIG. 7 showing a fourth preferred embodiment of the present invention, the self-drilling screw 3 also comprises a head 31, a shank 32, a drilling portion 33, and a set of thread section 34. In this embodiment, the screw 3 has a plurality of adjoining sub-drilling portions 35 formed between the drilling portion 33 and the thread section 34. Herein, the subsequent illustration is according to the sub-drilling portion 35 presenting of two, and each of the sub-drilling portions 35 still includes the same concatenations of elements as the same as those of the first preferred embodiment. Further, the cutting ridges 357 in this embodiment can perform in parallel to the shank axis α, or perform to be inclined to the shank axis α (not shown). Wherein, the screw 3 of this embodiment operates equivalently to the first embodiment and attains performances of the speedy screwing, decreased torque, as well as promoted screwing efficiency.

Giving the contrary comparison of the direct punching at once in the first embodiment, those sub-drilling portions 35 of FIG. 7 are able to be discretely punched, which means a die, whose length is identical to that of one sub-drilling portion 35, could be individually applied several times to form the joining and plural sub-drilling portions 35. Therefore, it needs not the large dies (not shown) to implement the integral molding at once, and such separate molding correspondingly conduces to a high strength and a reduced defective rate of the products as well. Hence, a technique level can be economized and the manufacturing costs can be reduced.

To sum up, the present invention takes advantage of at least one sub-drilling portion defined between the drilling portion and the thread section to lead an auxiliary drilling and provide a substantial guidance of debris. The swift extrusion of the redundant debris is hence obtained to avert a large screwing resistance as well as torque. Therefore, a favorable screwing efficiency is thence achieved and promoted.

While we have shown and described the embodiment in accordance with the present invention, it should be clear to those skilled in the art that further embodiments may be made without departing from the scope of the present invention.

I claim:

1. A self-drilling screw comprising:
a head;
a shank outwardly extended from said head and spiraled throughout by a set of thread section; and
a drilling portion formed at a distal end of said shank, opposite to said head; said drilling portion having a drill bit defined thereon and at least one flute arranged on said drill bit;
wherein, a sub-drilling portion being defined between said drilling portion and said thread section; said sub-drilling portion having a sub-drill body, an upper region located approximate to an end of said thread section, and a lower region disposed near said drill bit; said sub-drill body further provided with a sequence of indentations and prominent areas substantively defined between said upper and lower regions, and each indentation including a cutting surface extended upstream from one side thereof so as to form a cutting ridge by the convergence of said cutting surface with said adjacent prominent area.

2. The self-drilling screw as claimed in claim 1, wherein said screw includes a plurality of sub-drilling portions defined between said drilling portion and said thread section.

3. The self-drilling screw as claimed in claim 1, wherein said cutting ridge on said sub-drilling portion is parallel with respect to a shank axis.

4. The self-drilling screw as claimed in claim 2, wherein said cutting ridge on said sub-drilling portion is parallel with respect to a shank axis.

5. The self-drilling screw as claimed in claim 1, wherein said cutting ridge on said sub-drilling portion is inclined with respect to a shank axis.

6. The self-drilling screw as claimed in claim 2, wherein said cutting ridge on said sub-drilling portion is inclined with respect to a shank axis.

7. The self-drilling screw as claimed in claim 1, wherein an outer diameter of said upper region is larger than an outer diameter of said lower region.

8. The self-drilling screw as claimed in claim 2, wherein an outer diameter of said upper region is larger than an outer diameter of said lower region.
